(19) United States
(12) Patent Application Publication
(10) Pub. No.: US 2010/0110160 A1
(43) Pub. Date: May 6, 2010

(54) Videoconferencing Community with Live Images

(76) Inventors: Matthew K. Brandt, Driftwood, TX (US); Keith C. King, Austin, TX (US); Michael J. Burkett, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/261,202

(22) Filed: Oct. 30, 2008

(51) Int. Cl. H04N 7/15

(52) U.S. Cl. 348/14.08; 348/E07.083

(57) ABSTRACT

Indicating availability of users for videoconferencing using current images. A plurality of images may be provided on a display. Each image may indicate availability of a respective user for a videoconference. At least a subset of the images may be current images of the respective user. User input may be received which initiates a videoconference between a plurality of users represented by images in the plurality of images on the display. Accordingly, videoconferencing may be performed between the plurality of users in response to the user input.

### FIELD OF THE INVENTION

The present invention relates generally to conferencing and, more specifically, to a method for viewing availability for videoconferencing using live images.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to another (remote) participant. Each videoconferencing system may also include a display and speaker to reproduce video and audio received from a remote participant. Each videoconferencing system may also be coupled to a computer system to allow additional functionality into the videoconference. For example, additional functionality may include data conferencing (including displaying and/or modifying a document for both participants during the conference).

Current videoconferencing systems allow users to initiate videoconferencing with each other, but do not adequately indicate status and/or availability information before videoconferencing begins.

### SUMMARY OF THE INVENTION

Various embodiments are presented of a method for indicating availability of users for videoconferencing using live images.

A plurality of images may be provided on at least one display. In one embodiment, the plurality of images may compose or include an m by n array of images on the at least one display, (where at least one of m or n is greater than 1). Each image may indicate availability of a respective user for a videoconference. At least a subset of the images in the plurality of images may be live video or current images of the respective user. For example, some of the images may include a live image of a respective user at his respective workstation, if the respective user is currently present at his respective workstation. However, one or more of the images may be static images. In some embodiments, one or more of the images may indicate that the corresponding user is busy or wishes not to be disturbed. Alternatively, or additionally, one or more of the images may indicate that the corresponding user is in a videoconference or call.

In one embodiment, a subset of the users may be in a remote location from location of the images provided on the display. For example, a first user viewing the screen may be in a first location and at least one user shown in the display may be in a remote location from the first location. As used herein, “remote location” may refer to users that are not in the same building or complex as the first location, but may be located elsewhere, e.g., in a different city, different country, more than 1 mile away, more than 10 miles away, etc.

User input may be received to initiate a videoconference between a plurality of users represented by images in the plurality of images on the display. For example, the user input may be received to the images of the users desired to be in the videoconference. Videoconferencing may be established between the plurality of users in response to the user input. Thus a user may select various images on the display to establish a videoconference with the persons corresponding to the selected images.

### BRIEF DESCRIPTION OF THE DRAWINGS

A better understanding of the present invention may be obtained when the following detailed description is considered in conjunction with the following drawings, in which:

FIG. 1 illustrates a videoconferencing system participant location, according to an embodiment;

FIGS. 2A and 2B illustrate exemplary videoconferencing systems coupled in different configurations, according to some embodiments;

FIG. 3 is a flowchart diagrams illustrating an exemplary method for providing images indicating availability of users for videoconferencing, according to an embodiment; and

FIG. 4 is an exemplary image of a plurality of images indicating availability, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. Patent Application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

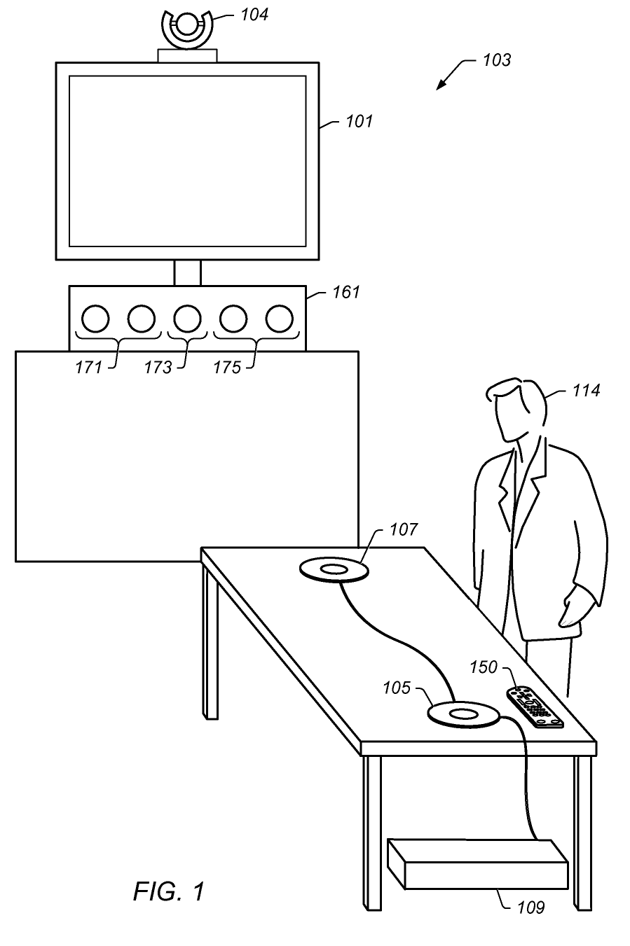

### FIG. 1—Exemplary Participant Location

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include a display 201 (e.g., an HDTV display). Images acquired by the camera 104 may be displayed locally on the display 101 and/or may be encoded and transmitted to other participant locations in the videoconference.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on a floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system. The conferencing system may be controlled by a participant or user through the user input components (e.g., buttons) on the speakerphones 105/107 and/or remote control 150. Other system interfaces may also be used.

In various embodiments, a codec may implement a real time transmission protocol. In some embodiments, a codec (which may be short for “compressor/decompressor”) may comprise any system and/or method for encoding and/or decoding (e.g., compressing and decompressing) data (e.g., audio and/or video data). For example, communication applications may use codecs to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, the videoconferencing system 103 may be designed to operate with normal display or high definition (HD) display capabilities. The videoconferencing system 103 may operate with a network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system with a video camera, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference. As noted above, one problem with current videoconferencing systems is that a typical videoconferencing system application does not indicate the status or provide images corresponding to the user's current status/availability. Embodiments of the invention described herein provide images which may indicate the availability of various users for a videoconference.

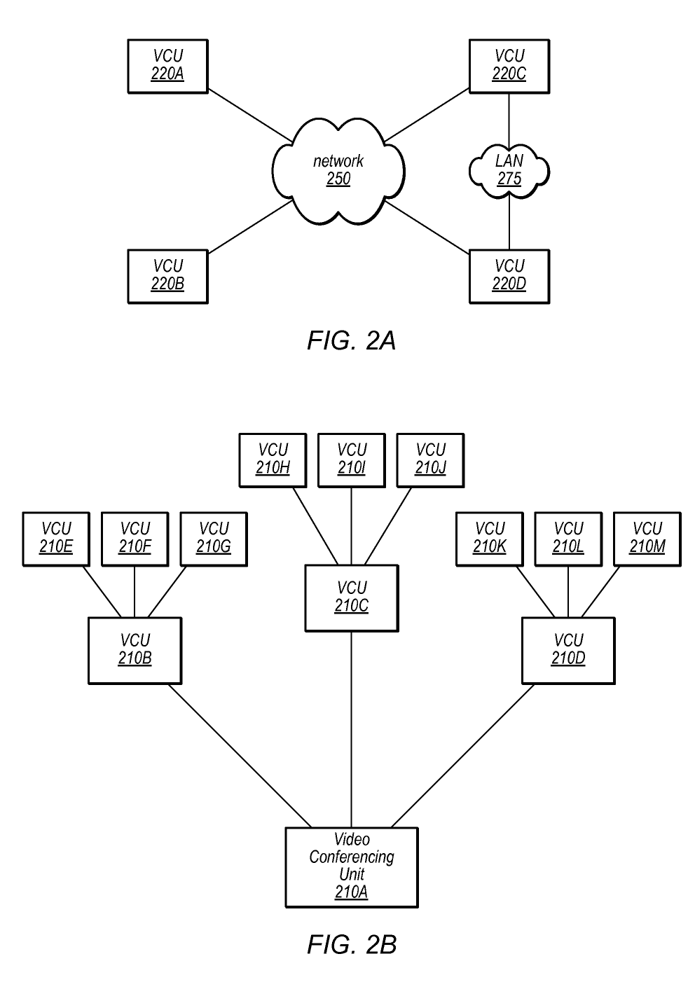

### FIGS. 2A and 2B—Coupled Videoconferencing Systems

FIGS. 2A and 2B illustrate different configurations of videoconferencing systems. The videoconferencing systems may be operable to provide images regarding status, e.g., as described in more detail below, e.g., using one or more videoconferencing application(s) stored by the videoconferencing systems. As shown in FIG. 2A, videoconferencing systems (VCUs) 220A-D (e.g., videoconferencing systems 103 described above) may be connected via network 250 (e.g., a wide area network such as the Internet) and VCU 220C and 220D may be coupled over a local area network (LAN) 275. The networks may be any type of network (e.g., wired or wireless) as desired. These videoconferencing systems may discover provide status images according to embodiments described below, among others.

FIG. 2B illustrates a relationship view of videoconferencing systems 210A-210M. As shown, videoconferencing system 210A may be aware of VCU 210B-210D, each of which may be aware of further VCU's (210E-210G, 210H-210J, and 210K-210M respectively). VCU 210A may be operable to display status images corresponding to one or more of the VCUs 210B-210M according to the methods described herein, among others. In a similar manner, each of the other VCUs shown in FIG. 2B, such as VCU 210H, may be able to display images corresponding to a subset or all of the other ones of the VCUs shown in FIG. 2B. Similar remarks apply to VCUs 220A-D in FIG. 2A.

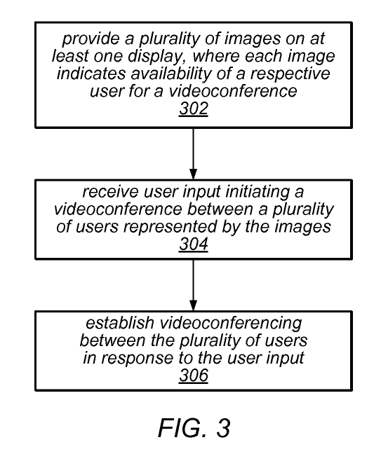

### FIG. 3—Method for Providing Images Indicating Availability of Users

FIG. 3 illustrates a method for providing images indicating availability of users for a videoconference. The method shown in FIG. 3 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

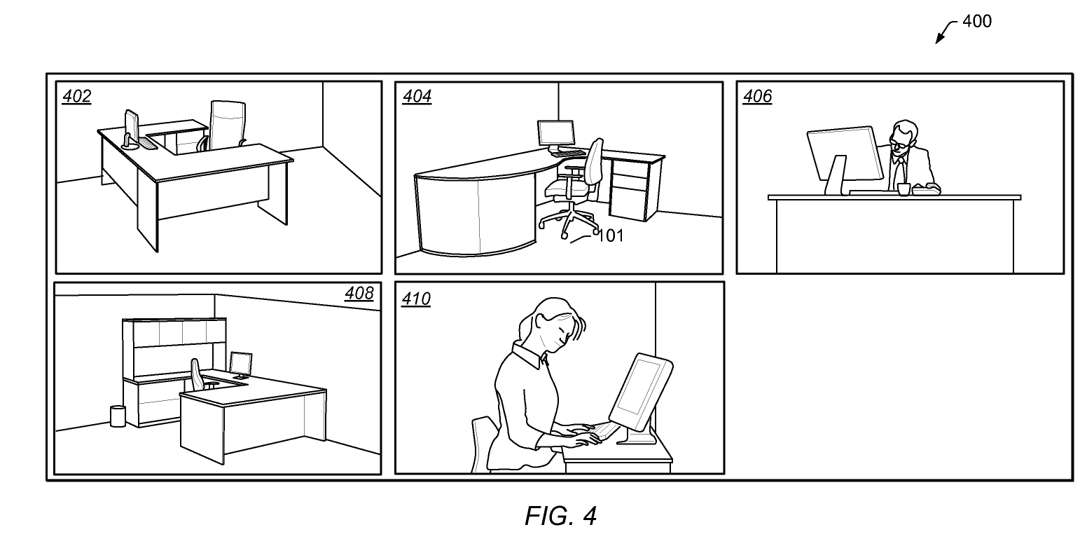

In 302, a plurality of images may be provided on a display. The images may indicate the availability of a respective user represented by the image for a videoconference, as described in more detail below. In one embodiment, the plurality of images may be provided in the GUI of a videoconferencing system. The images may be provided in an m by n array that may be provided on the display. At least one of m and n may be greater than 1. However, it should be noted that the array may not be completely full of images. For example, FIG. 4 illustrates an exemplary array of images (in this case, including 5 images in a 2×3 array) where the array of images is not filled to the maximum 6 images. Alternative configurations for the images (e.g., other than an array) are envisioned. For example, the images could be displayed in a “buddy list”, e.g., next to text identifying the persons represented by the images on the display. Note that a first user viewing the images on the display may be able to configure or rearrange the images on the display, as desired.

However, while various embodiments are described where the images are provided on a single display, the plurality of images may be distributed across a plurality of displays (e.g., one display for each image, although other distributions are envisioned). Such a display could be provided in a conference room or lobby area of a building, where each display may correspond to a respective worker in the building. In some embodiments, each display may rotate through a plurality of users thereby allowing the plurality of displays to display a larger number of users than displays over a given period of time.

As indicated above, each image on the display(s) may indicate availability of a respective user for a videoconference. In one embodiment, the image of a respective user may be provided by that respective user's videoconferencing camera. In other words, a user sitting at his desk may have a camera positioned to provide images of his upper body, etc., and the images captured by this camera may be used to provide the live images described here. For example, the camera may be mounted next to his computer display, or integrated into his compute display.

Each of the images (or at least a subset of the images) may be current images of the office or present location of the videoconferencing system corresponding to a user. Thus, the current image may indicate whether or not the user is in the office or at the location of the videoconferencing system. More specifically, the current image may indicate whether or not the user is available for a videoconference. For example, the current image may indicate whether the user is in his office or workstation, talking to another office worker, on the phone, in a videoconference, wishes not to be disturbed, is in the middle of a project, etc.

As used herein, “current image” refers to an image which is updated often enough to indicate with some degree of certainty whether or not the user is available for a videoconference. For example, a current image may be a live video stream, e.g., that is video encoded using one of various available codecs. However, slower update rates are envisioned for current images. For example, a current image could be updated every second, every 10 seconds, every 15 seconds, every 30 seconds, every 45 seconds, every minute, every five minutes and/or other similar variations. However, as indicated above, the image could be updated more than once a second, e.g., as a live video image, such as 10, 20 30, or 60 frames per second. In some embodiments, the update rate of the current image may be determined based on preferences of the respective user in the image, the user viewing the image(s) (referred to herein as the “first user”), the communication bandwidth of either of the respective user and/or the first user, and/or based on other factors.

In the exemplary plurality of images of FIG. 4, image 402 indicates the user is not available (as he is not in the office). Similarly, users in 404 and 408 are also not available. However, as shown, users 406 and 410 are available as indicated by the images. Thus, the current images shown in FIG. 4 indicate the availability of the respective users for a videoconference.

However, some of the images may be static images. More specifically, the static image may represent the respective user, e.g., as a picture of the user, an avatar of the user, and/or other representative pictures. Alternatively, or additionally, the static image may indicate the status/availability of the user. For example, the user may desire to indicate his availability but not have a live picture of himself displayed to other users. In this case, the user may select a static image that indicates he is available (e.g., “working and available”).

As another example, the static image may indicate the user is on vacation, e.g., showing a picture of a beach with palm trees, a ski resort, or a personalize picture of the actual user on vacation, playing golf, etc. Thus, the vacation image may even indicate what kind of vacation the user is on, if the user so desired. In one embodiment, while the user is on vacation, the user may provide (upload) updated pictures of his vacation for presentation to other users.

The static image could also indicate whether the user has come to work yet and/or has left work, e.g. to go home or to go to lunch. Furthermore, the static image could indicate if the user is away on a business trip (e.g., even indicating the location of the business trip). As one example, if the user is on a business trip in Europe visiting 5 different cities, the user may configure images to appear on different days indicating the user's current location. This apprises other users of the respective user's current location, in case others need to correspond with the respective user. The respective user on the business trip may also upload various images for display while on the trip.

Additionally, the image could indicate the user does not wish to be disturbed. For example, the image could be a picture with text such as “I am busy” or “On the Phone” or “Leave me alone”, etc. The “do not disturb” image could in addition, or instead, be an image that indicates the user is busy, e.g., an image of the user on the phone, etc. The image could also have a static background color (e.g., a black image) or other message. In some embodiments, the background color could also indicate status information, e.g., where black indicates the user is not at work yet or has left work, and red may indicate the user is at work, but does not wish to be disturbed, has temporarily left his office, etc. Other color combination/statuses are envisioned. Note that as used herein, a “static image” differs from a “current image” or “live image” in that the static image does not represent an actual current or changing image of the respective user or his workstation. A static image may in fact indicate the current status/availability of the user (e.g., according to the methods described herein, among others) and may in fact change based on actions of the user. For example, if the user picks up the telephone to make a call, a static image of a telephone, or a person on the telephone, may replace the current live image of the user. Thus here a static image may be used to visually indicate that the user is using the telephone, instead of a live image of the user using the telephone. This may be desirable where the user desires privacy during the call.

In some embodiments, as noted above, one or more the images may include text, e.g., overlaid on the image. For example, the text “do not disturb” or “DND” could be displayed over a current image or a static image (or background) in order to indicate that the user wishes not to be disturbed. Other text indicating status information is envisioned, e.g., “on vacation”, “sick”, “at home”, “on business trip”, “away from the desk”, “be right back”, “working on critical project”, “on a call”, “in a videoconference”, among others. In one embodiment, the user may be able to choose one of these status messages from a list of default status messages. However, in some embodiments, the user may be able to set or create his own status message or away message (which could be saved as a default or stored message for later use). For example, the user may be able to put the text “working on project X, due tomorrow morning” (where “X” is the current project) over his current or static image. Alternatively, the user could modify one of the default messages, such as “on business trip” and then add “to India, will return December 12” in order to provide more information to his coworkers or family. Thus, in some embodiments, text may be overlaid on top of the images (static or current) and may provide more details on the respective user's current status and/or availability for videoconference.

In some embodiments, the user's status may be changed automatically (e.g., by the first user's videoconferencing system). For example, e.g., where no computer input is detected, the user's status may change from “active” to “idle”. In some embodiments, an “idle” status may be indicated with text, or a slightly grayed out version of the current image or static image may be displayed. Additionally, or alternatively, the changes in the images of the video input (e.g., for the current image) may be monitored. Where an image of the user is not detected in the captured image (because the user is away from his desk), or no significant change has occurred over a given time period (e.g., 30 seconds, a minute, etc.), the user's status may be changed from “active” to “idle” or “away from the office”. In the reverse sense, when a user becomes active (e.g., by providing input on the computer, reentering the office, his image being detected in the captured image, or the user moves around causing a change in the current pictures over a given period of time or frames) the “idle” or “away from office” status may change back to active. In one embodiment, this change may be indicated in the GUI of the videoconferencing system by highlighting the image or providing a sound, among other options. Note that such indications could be associated with any of various changes in status, e.g., based on user preferences.

The detection of changes in status could be performed locally, e.g., by the first user's videoconferencing system for the first user, or remotely, e.g., by the first user's videoconferencing system for the respective users, based on the provided current images. Thus, in one embodiment, the first user's videoconferencing system may keep track of and update statuses of the respective user's represented by the images independently of the provided images. Alternatively, or additionally, the remote videoconferencing systems may provide status updates to the first user's videoconferencing system (or possibly to a server, which may then provide the updates to the first user's videoconferencing system.

In one embodiment, if the user is currently participating a in a videoconference, a static image may appear to indicate the user is so engaged. When the user completes the current videoconference, a live image of the user may again be provided (or alternatively a static image indicating the user is now available).

In 304, user input may be received to initiate a videoconference between a plurality of users. The plurality of users may be represented by images in the plurality of images on the display. For example, in one embodiment, the first user may initiate a videoconference by selecting images of the users on the display. In one embodiment, the user could select each image and then select an “initiate videoconference” button in the videoconferencing software. Alternatively, the first user could join a video conference by selecting images corresponding to users already in a videoconference. Thus, the first user could initiate a videoconference (from his perspective) by joining an in-progress videoconference. Note that prior to initiating the videoconference, no audio may be provided to the audio. In other words, the plurality of images may be graphical only and no audio from those locations may be provided until a videoconference is established.

In 306, a videoconference may be established between the plurality users in response to the user input in 304. The videoconference may be established using any of various videoconferencing techniques known by those of skill in the art. For example, various techniques described in U.S. patent application Ser. Nos. 11/252,238 and 11/251,086, which were incorporated by reference in their entirety above, may be used.

Once the videoconference is established, the first user's status may be changed from, for example, available, to “in call” or “on a videoconference”. Thus, the status of the first user may automatically change based on the initiation of the videoconference. Additionally, the videoconference may be displayed in a new videoconferencing window or may simply use the respective displayed images, as desired.

Note that one or more of the respective users may be in a remote location, e.g., relative to the first user. As used herein “remote location” refers to a location that is located in a different location than the first user. For example, the remote user and the first user may not be in the same building. In various embodiments, the remote user could be at his home (as opposed to the first user who may be at an office building), in a different office building, in a different city, in a different country, etc. Thus, by providing a system where a user can easily see and interact with other users, a remote user may feel less isolated, and may conveniently interact and collaborate with other workers, thereby providing a sense of community for the remote user. Similarly, such a system (when used in conference room) may allow remote users to interact and be a part of business meetings even when not at the location of the business. Note that in some embodiments, one of the images may represent such a conference room rather than a worker's office. Correspondingly, the first user could see that people were gathering in the conference room and join the meeting by selecting the conference room and initiating the videoconference, e.g., according to the method described above. Once initiated, the first user could interact with the group in the conference room and be able to hear audio from the conference room. Additionally, note that while the above description is provided with respect to remote users, the same benefits may apply to those workers that are not remote.

### EXAMPLE

As one example, a company or organization may have offices in New York, Austin, and Los Angeles. Thus, each of the offices may include a variable number of workers (in this example, 10 workers each). In any given day, one or more workers may be working from home or working abroad (e.g., to meet with a client). The above-described method lets each of these users feel included in the company as a whole, as opposed to their individual location, such as one of the offices. Additionally, as indicated above, a worker at home or abroad may particularly feel connected to the other workers as opposed to being isolated and alone. Each worker may include a plurality of icons on his respective computer display (or another display, as desired). Each of the icons may correspond to other workers in the company, e.g., abroad, at home, in New York, in Austin, or in Las Angeles. Thus, as indicated above, each icon may display a current image of the users at their respective desks (if they are currently at their desk). Additionally, that worker's selected static image or current image may be sent to other workers in the company to indicate his availability for a videoconference, for display in their plurality of icons.

Further, one or more of the offices may include a conference room that may have a large screen or a plurality of screens for performing a videoconference. Each of the users may then use the icons to initiate a videoconference with a plurality of other workers in the company, e.g., by selecting their respective icons or joining a conference that is just beginning. In the conference room setting, a user from Austin may join in on a conference that is physically in New York, as well as another user working remotely from home in New Jersey. Thus, in the conference room the live feeds may be displayed on the plurality of screens and all of the users (those physically in New York and those in Austin and New Jersey) may be able to interact in a relatively normal fashion, due to the convenient set up of the conference room. Note that the conference may be initiated with the conference room from either the conference room (e.g., by a worker in the conference room selecting an icon of the worker in Austin on one of the displays) or from Austin or New Jersey (e.g., by the worker in Austin selecting the icon for the conference room in New York).

### Specific Embodiments

The following provides specific embodiments for how the method of FIG. 3 may be performed. Note that these descriptions are exemplary only and other embodiments are envisioned.

In one embodiment, a server may maintain the current images/video streams and/or static images for the plurality of images. In a first embodiment, the server may receive and then provide (to the other videoconferencing systems) periodic still pictures (JPEG snapshots) of each user. For this embodiment, each videoconferencing system may open a TCP connection to port 80 of the server. If the server supports it, this connection may be encrypted using TLS. This may allow ensuing conversations to be able to use the normal HTTP mechanism for access. This TCP connection may be maintained for the duration of the respective videoconferencing system's participation in the provision and reception of the plurality of images (referred to herein as the “community”).

Once the connection is open, the videoconferencing system may send information (e.g., images) to the server. In one embodiment, each line of information may include a start character “S” followed by the computer (or endpoint) name, IPv4 address, IPv6 address (if available), and status text in CSV format. This line of information may be sent once at the start of the session and each time the status changes.

The server may then send a list of computers currently participating in the community to each videoconferencing system as a single line beginning with “P” followed by a CSV list of IPv4 addresses. This may be performed once at the start of the session and every time a user joins or leaves the community. The videoconferencing system can signal to the server that it wishes to receive information about a participant in its feed by sending a line starting with “M” followed by the IPv4 address of the participant. Each time a new JPEG snapshot is available, the corresponding videoconferencing system may upload it by sending a line starting with “J” followed by the number of bytes in the JPEG snapshot, a new line and the JPEG data. The JPEG data may be followed by a new line as well. When the new JPEG snapshot is received from a videoconferencing system, all stations monitoring it may receive the snapshot in the same form it is sent. When a user leaves the community, the TCP connection is torn down.

However, in alternate embodiments, a low resolution (¼ CIF) live video-only feed of each user may be received and then encoded for distribution for the other videoconferencing systems. The simple form can easily be implemented in standard server hardware. Such an embodiment, may require a server or videoconferencing system that can integrate many H.26x streams and generate encoded video for each participant. The various embodiments described above may be modified to incorporate this ability.

### Use Cases

Passive Participation—In this mode, the videoconferencing system may join the community using a server and system name, e.g., in response to a user's selection to join the community, which may be preference. When the active preference becomes true, the community connection may be established, e.g., as described above, and a list of available participants may be populated. At least a subset of these (e.g., up to the maximum number of displayable snapshots) may be selected and displayed on the display, e.g., as in 302 above. Status information for each monitored participant may be updated periodically, e.g., based on a status preference for that IP address or particular user. The current image or static image may be updated each time a new snapshot is received. In one embodiment, the videoconferencing may display the snapshots in a grid or array, updating each image as it is received and overlay the status information in a pleasing format.

Selection and calling within the community—The first user may be able to highlight each participant, e.g., with a mouse, a remote control, or other user interface device. Selecting that participant may highlight the image and add that user to a call list. In one embodiment, highlighting could be performed by surrounding the participant's JPEG with a highlight color rectangle. Participants currently in the call list could be surrounded by a different color rectangle. Once all the desired users are selected, the first user may press a call button to attempt to establish a videoconference with the selected participants. Depending on the number of participants involved in a call and the available bandwidth on each link, the call might be placed using an internal MCU, another user's MCU, an MCU in the cloud, or a videoconferencing server.

### Client Implementation

At the client videoconferencing system, the community service may be implemented by a daemon. The daemon may monitor and maintain the following preferences:
/config/community/server IP address or DNS name of the community server
/gui/styles/systemName name of this station
/config/community/user username to log in to community server
/var/community/join set to true to connect to community server
/config/community/password community server login password
/config/community/status current status of this participant
/var/community/active set to true when community is connected
/var/community/monitor comma separated list of monitored participants
/var/community/<ip>/status CSV information about monitored stations
/var/community/snap updated to filename when a new snapshot is received
/var/community/available comma separated list of current participants (IPv4)

The bold preferences may be set by the videoconferencing system, and the rest may be maintained by the community daemon and read by the videoconferencing system.

### Additional Embodiments

The following provides additional features that may be incorporated to the above descriptions.

In one embodiment, the first user may be able to send an audio message (or other multimedia message) to other participants, e.g., represented by the plurality of images, without having to initiate a videoconference. For example, the first user could select which participants should receive the audio message or “shout”, record the message (e.g., “please gather in the conference room for our 9:00 meeting” or “lunch time!”) and select a send or “shout” button to send it to the selected participants. Note that there are many different methods for selecting and sending the message to the desired participants other than the one described above. For example, in one embodiment, the first user could select an image of a desired user, keep the mouse or remote button depressed, say his message, and release the button, thereby sending the shout to the selected user. Thus, in some embodiments, the user may provide a recorded audio message to selected users without having to initiate a phone call or videoconference.

In one embodiment, the display (or the plurality of displays) may not be usable as to activate a videoconference. For example, where the display(s) are presented in a conference room or lobby of a company, the images may simply provide a graphical representation of the workers present in the company, thus providing a sense of the community in the company, but may not necessarily be used to initiate videoconferences as in the descriptions above.

Furthermore, each of the users corresponding to the plurality of images may be members of that “community”. There may be a plurality of different communities which the users may join. For example, a user may join his company's community, his family's community, his friend's community, etc. In one embodiment, various communities may have sub-communities. For example, the company's community may have sub-communities such as an engineering department community, a marketing community, an executive community, etc.

Note that the user may be able to join a plurality of communities or only one community at a time, as desired. For example, the user may be a member of the engineering community in his company, and therefore he may see only his engineering peers in the plurality of images. The user could then leave that community (e.g., via graphical input) and join another community, such as the marketing community, in order to see that community's status, discuss marketing concepts with respect to a new product, etc. Once that discussion or other actions are completed, the user could then rejoin the engineering community.

The user may be able to leave, join, or navigate various communities via various different methods. For example, a graphical representation of communities may be displayed to the user which may show a hierarchy of communities (e.g., parent communities such as the company and sub-communities such as the various groups within the community) or connectivity between communities (e.g., company A may be related to company B and may be therefore shown as being connected). Furthermore, connectivity between communities based on linkages between people may be graphically shown to the user, e.g., for navigating between related communities. For example, if community A and community B have 20 people in common, they may be displayed closer to each other. Additionally or alternatively, connectivity may be indicated when there are many connections between the two communities. For example, if members of community A have many “buddies” that are in community B, the two communities may be displayed as closely linked or closer together in the graphical representation. Thus, in one embodiment, distances in the graphical representation may indicate the closeness of the members of the two communities.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method comprising:
providing a plurality of images on at least one display, wherein each image indicates availability of a respective user for a videoconference, wherein at least a subset of the images in the plurality of images are current images of the respective user;
receiving user input initiating a videoconference between a plurality of users represented by images in the plurality of images on the at least one display; and
establishing videoconferencing between the plurality of users in response to the user input.

2. The method of claim 1, wherein the at least a subset of the images comprise a current image of a respective user at his respective workstation, if the respective user is currently present at his respective workstation.

3. The method of claim 1, wherein the user input is received to the images in the plurality of images which represent the plurality of users in the videoconference.

4. The method of claim 1, wherein the plurality of images comprise an m by n array of images on the at least one display, wherein at least one of m or n is greater than 1.

5. The method of claim 1, wherein one or more of the plurality of images are static images.

6. The method of claim 1, wherein one or more of the plurality of images indicate that the corresponding user is busy or wishes not to be disturbed.

7. The method of claim 1, wherein one or more of the plurality of images indicate that the corresponding user is in a videoconference or call.

8. The method of claim 1, wherein at least one of the plurality of users is in a remote location.

9. A computer accessible memory medium comprising program instructions, wherein the program instructions are executable by a processor to:
provide a plurality of images on at least one display, wherein each image indicates availability of a respective user for a videoconference, wherein at least a subset of the images in the plurality of images are current images of the respective user;
receive user input initiating a videoconference between a plurality of users represented by images in the plurality of images on the at least one display; and
establish videoconferencing between the plurality of users in response to the user input.

10. The memory medium of claim 9, wherein the at least a subset of the images comprise a current image of a respective user at his respective workstation, if the respective user is currently present at his respective workstation.

11. The memory medium of claim 9, wherein the user input is received to the images in the plurality of images which represent the plurality of users in the videoconference.

12. The memory medium of claim 9, wherein the plurality of images comprise an m by n array of images on the at least one display, wherein at least one of m or n is greater than 1.

13. The memory medium of claim 9, wherein one or more of the plurality of images are static images.

14. The memory medium of claim 9, wherein one or more of the plurality of images indicate that the corresponding user is busy or wishes not to be disturbed.

15. The memory medium of claim 9, wherein one or more of the plurality of images indicate that the corresponding user is in a videoconference or call.

16. The memory medium of claim 9, wherein at least one of the plurality of users is in a remote location.

17. A system, comprising:
a processor;
a multimedia input coupled to the processor;
a multimedia output coupled to the processor;
a memory medium comprising program instructions, wherein the program instructions are executable by the processor to:
provide a plurality of images on the multimedia output, wherein each image indicates availability of a respective user for a videoconference, wherein at least a subset of the images in the plurality of images are current images of the respective user;
receive user input initiating a videoconference between a plurality of users represented by images in the plurality of images on the at least one display; and
perform videoconferencing between the plurality of users in response to the user input, wherein said performing uses the multimedia input and multimedia output to perform the videoconference.

18. The system of claim 17, wherein the user input is received to the images in the plurality of images which represent the plurality of users in the videoconference.

19. The system of claim 17, wherein the plurality of images comprise an m by n array of images on the at least one display, wherein at least one of m or n is greater than 1.

20. A method comprising:
providing a plurality of images on one or more displays, wherein the one or more displays are co-located at a first location;
wherein at least a subset of the images comprise a current image of the respective user at his/her respective workstation, if the user is currently present at his/her respective workstation.
wherein one or more of the images in the array of images indicate that the corresponding user is busy or wishes not to be disturbed
wherein at least one of the images corresponds to a user in a remote location from the first location;
wherein each image indicates availability of a user for a videoconference.
